(19) United States
(12) Patent Application Publication
(10) Pub. No.: US 2010/0245894 A1
(43) Pub. Date: Sep. 30, 2010

(54) DIRECT-SCAN-TO-PRINT SCANNER AND RELATED METHOD

(75) Inventors: Mi-lai Tsai, Keelung City (TW); Shang-wen Huang, Yonghe City (TW); Chih-kuang Hsu, Zhonghe City (TW); Liang-yu Chang, Miaoli City (TW); Fu-Iiang Kao, Xindian City (TW); Tsung-en Tsai, Kaohsiung City (TW)

Correspondence Address: AUSTIN RAPP & HARDMAN, 170 South Main Street, Suite 735, SALT LAKE CITY, UT, 84101, US

(73) Assignee: Genesys Logic, Inc., Shindian City (TW)

(21) Appl. No.: 12/560,984

(22) Filed: Sep. 16, 2009

(30) Foreign Application Priority Data
Mar. 31, 2009 (TW) 098110724

(51) Int. Cl. G06F 3/12; H04N 1/04

(52) U.S. Cl. 358/1.15; 358/474

(57) ABSTRACT

A scanning device capable of directly sending scanned images to a printing device to be printed and a related method are proposed. An image information is obtained by scanning with an image sensor module, and then stored in a storage device. When a print client detects a print request, a storing server delivers the image information to the printing device through a picture transfer protocol. Accordingly, the image information is to be printed upon a direct link between the printing device and the scanning device without needing a computer serving as a bridge.

### CLAIM OF PRIORITY

This application claims priority to Taiwanese Patent Application No. 098110724 filed on Mar. 31, 2009.

### BACKGROUND OF THE INVENTION

1. Field of the Invention

The present invention relates to a scanning device that can directly print the scanning results via a printer and the relative method, and more particularly, to a scanning device that can support the PictBridge protocol that allows printing the scanning results via a printer and the relative method.

2. Description of Prior Art

Printers, as a subordinate of a computer peripheral system, have been developing for a long time. Based upon such an application, printers usually provide a set of printer control languages to facilitate computer software to communicate with the printers. Also, the set of printer control languages have to convert materials that require to be printed out to a format that can be accepted and recognized by the printers to complete printing tasks.

Scanners, a common computer image input device, are similar to printers that connect to computers. When computer software manages to acquire external images via a scanner, the computer will give a command to control the scanner to perform the task of image-capturing under a control agreement provided by the scanner.

Owing to the development of office automation and electronic documents, the popularity of printers and scanners has been rising. Some manufacturers have proposed a convenient document-copying project; that is to say, scanners, replacing computers, can directly interpret images which require to be printed out into a set of control languages that printers can understand. However, because scanners may be connected to different kinds of printers with non-unified specifications and control languages set forth by each manufacturer, it is almost impossible for scanners to connect and control all printers. The non-unified specifications and control languages are the biggest obstacles to the development of the direct printing for scanners.

Since digital cameras become the mainstream of photography, Camera and Imaging Production Association (CIPA) of Japan proposed the PictBridge protocol to solve the complicated procedure for usage; that is to say, photos can only be printed out via a computer. The PictBridge protocol is related to a direct printing connecting a camera to a printer. The PictBridge protocol regulates a Universal Serial Bus (USB) as the transmission interface. Picture Transfer Protocol (PTP) is the standard of all of the information transfer protocols. As long as a camera and a printer correspond to the standard, they can easily connect to each other, and photos can be printed out directly without a computer.

Nowadays the PictBridge protocol regulates products, such as digital cameras, digital video recorders, camera phones, and printers. The PictBridge protocol requires that an image input device must have the function of server-saving, i.e., image-saving. However, based upon the development of conventional scanners, the scanners per se are not equipped with the function of image-saving. And the scanners divide images into lots of very small segments and transmit these segments to the computer or printer processing the image input, which does not meet the requirement of the PictBridge protocol. So, the conventional scanners cannot connect the printers regulated by the PictBridge protocol to cooperate. Therefore, to develop a scanning device that can directly print out the scanning results via a printer is the industry's ultimate goal.

### SUMMARY OF THE INVENTION

It is therefore a primary objective of this invention to provide a scanning device that can print the scanning results directly via a printer and the relative method. The scanning device manages to equip a function of complete image-saving and a storing server capable of complying with the PictBridge protocol. In this way, the scanning device can print out the scanning results via the printer by supporting the PictBridge protocol.

Briefly summarized, a scanning device for printing a scanning result via a printing device comprises an image sensor module, an image sensing circuit, a system controller, a storage device, a print client, and a storing server. The image sensor module is used for scanning an object to generate an induced signal. The image sensing circuit which is coupled to the image sensor module is used for converting the induced signal into an image signal. The system controller which is coupled to the image sensing circuit is used for processing the image signal to generate image information relating to the object. The storage device is used for storing the image information. The print client which is coupled to the system controller is used for detecting an inquiry signal from the printing device, and responding a working signal. The storing server is used for transmitting the image information from the storage device to the printing device by using Picture Transfer Protocol (PTP).

In one aspect of the present invention, the scanning device further comprises a motor for activating a movement of the image sensor module, and a motor controller for driving the motor in response to a motor-driving signal from the system controller to activate the movement of the image sensor module.

In another aspect of the present invention, the image sensor module comprises a light source for generating light to the object, a lens for focusing the reflected light from the object, and a photoelectric sensor for converting the sensing light intensity into the analog induced signal.

In still another aspect of the present invention, the working signal from the print client comprises a printing-initiated signal and an idling signal.

In yet another aspect of the present invention, the scanning device further comprises an interface controller for transmitting the image information to the printing device. And the interface controller transmits the image information by using a Universal Serial Bus (USB) protocol.

According to the claimed invention, a method of printing a scanning result of a scanning device via a printing device is proposed. The printing device comprises a print server and a storage client. The scanning device comprises a storing server, a print client, and a storage device. The method comprises the steps of: linking the printing device and the scanning device, the printing device sending an inquiry signal to the scanning device; scanning an object with the scanning device to generate an image information, and storing the image information into the storage device; conveying a printing-initiated signal to the printing device when the scanning device generating a printing instruction; the scanning device transmitting the image information to the printing device; and the printing device printing out the image information.

These and other objectives of the present invention will become apparent to those of ordinary skill in the art after reading the following detailed description of the preferred embodiment that is illustrated in the various figures and drawings.

### BRIEF DESCRIPTION OF THE DRAWINGS

FIG. 1 shows a block diagram of a printing device and a scanning device according to a preferred embodiment of the present invention.

FIG. 2 demonstrates a flow chart of a method of printing out the scanning outcome of the scanning device via the printing device according to the present invention.

FIG. 3 shows a schematic diagram of the printing device and the scanning device to print out data, based upon the PictBridge protocol.

### DETAILED DESCRIPTION OF THE PREFERRED EMBODIMENTS

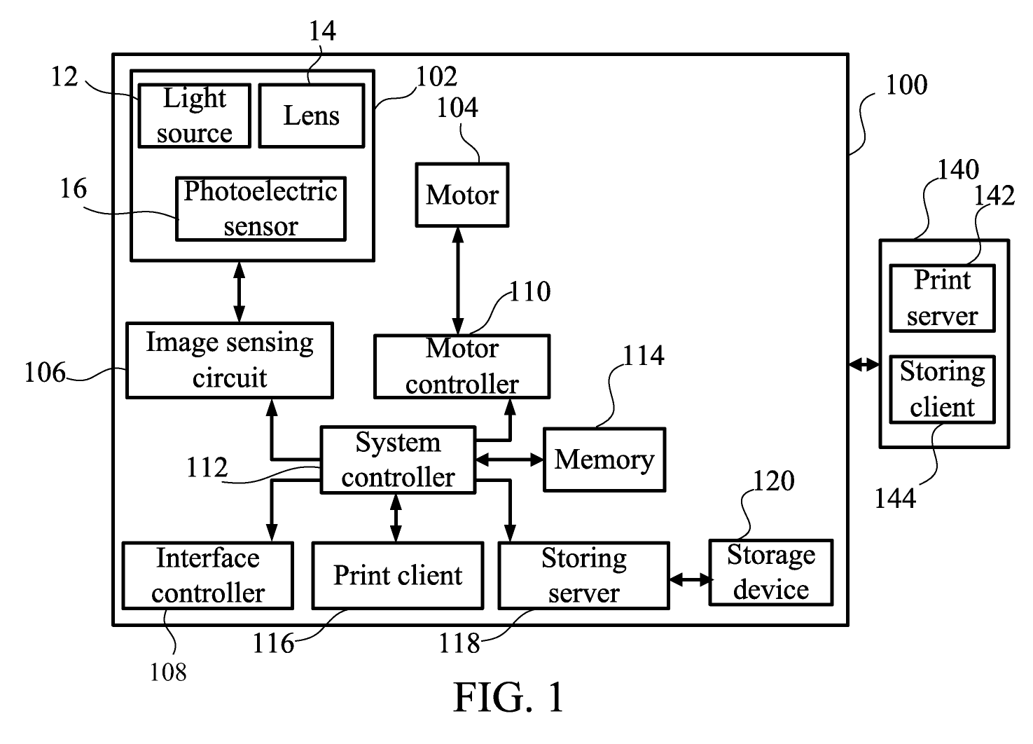

Referring to FIG. 1 showing a block diagram of a printing device 140 and a scanning device 100 according to a preferred embodiment of the present invention, the scanning device 100 comprises an image sensor module 102, a motor 104, an image sensing circuit 106, an interface controller 108, a motor controller 110, a system controller 112, a memory 114, a print client 116, a storing server 118, and a storage device 120. The scanning device 100 refers to an optical device that can scan an object to generate the object's image. The image sensor module 102 which comprises a light source 12, lens 14, and a photoelectric sensor 16 is used for scanning an object to generate an induced signal. The printing device 140 which comprises a print server 142 and a storing client 144 is used for printing out image which is scanned by the scanning device 100.

When the scanning device 100 starts to perform its tasks, the system controller 112 generates a motor-driving signal to the motor controller 110 and causes the motor controller 110 to drive the motor 104 to activate the movement of the image sensor module 102. Meanwhile, the light source 12 inside the image sensor module 102 sends out light onto an object and then the light is reflected. The reflected light is focused on the photoelectric sensor 16 of which the dimension is the same as that of the scan view of the scanning device 100 via the lens 14. The photoelectric sensor 16 converts sensing light intensity into analog induced signals. The image sensing circuit 106 converts the analog induced signals into digital image signals and outputs them to the system controller 112. After the system controller 112 processes, the digital image signals will be transformed into complete image information of the scanned object. Finally, the generated image information will be stored in the storage device 120. The memory 114 is utilized to temporarily store information that the system controller 112 requires in operation.

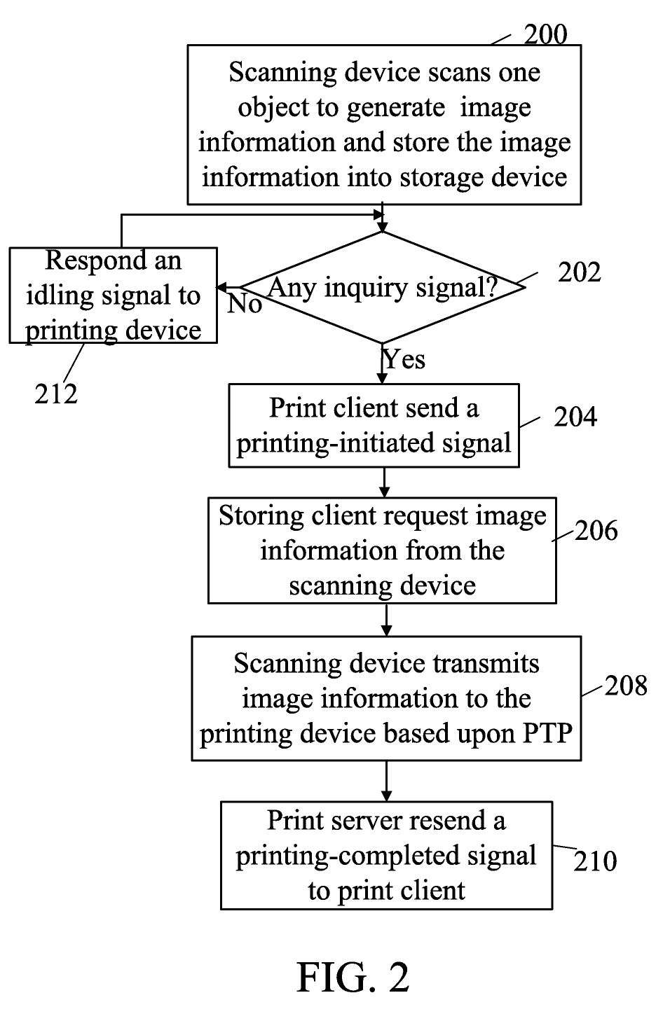

Referring to FIG. 1 and FIG. 2, FIG. 2 demonstrates a flow chart of a method of printing out the scanning outcome of the scanning device 100 via the printing device 140 according to the present invention. The method comprises the following steps:

Step 200: The scanning device 100 scans one object to generate some image information and store the image information into the storage device 120.

Step 202: The print client 116 detects if any inquiry signal comes from the printing device 140.

Step 204: When the print client 116 detects an inquiry signal coming from the printing device 140, the print client 116 of the scanning device 100 will resend a printing-initiated signal.

Step 206: When the printing device 140 receives the printing initial signal, the storing client 144 of the printing device 140 will request the image information from the scanning device 100.

Step 208: The scanning device 100 transmits the image information stored in the storage device 120 to the printing device 140 via the storing server 118 based upon Picture Transfer Protocol (PTP).

Step 210: When the printing device 140 completes printing the image information, the print server 142 of the printing device 140 will resend a printing-completed signal to the print client 116.

Step 212: The print client 116 responds an idling signal to the printing device 140.

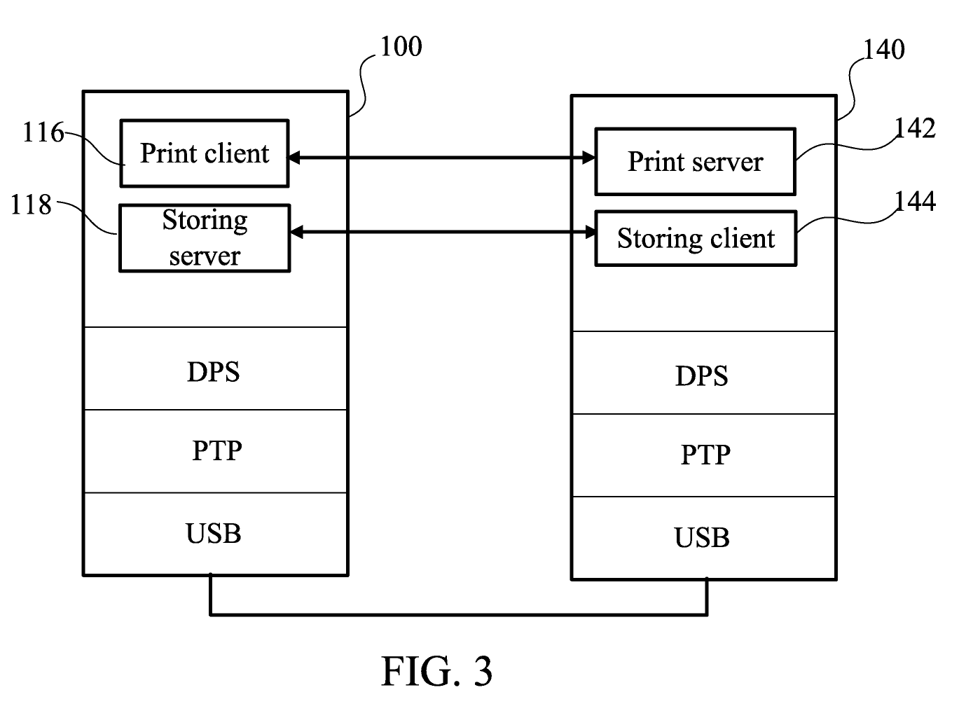

Referring to FIG. 1 and FIG. 3, FIG. 3 shows a schematic diagram of the printing device 140 and the scanning device 100 to print out data, based upon the PictBridge protocol. When the scanning device 100 connects the printing device 140, the print server 142 will inquire the scanning device 100 if any data requires to be printed out by a way of polling to determine if any image information needs printing and then to resend a working signal (Step 202). If a user does not operate an image collection device to print something, the print client 116 of the scanning device 100 will respond an idling signal, i.e., a message of “NO JOB” regulated in PictBridge protocol specification, to the printing device 140 (Step 212). If a user gives a print command to the scanning device 100, the print client 116 of the scanning device 100 will respond and transmit a printing-initiated signal, i.e., a message of “DPS_STARTJOB” regulated in PictBridge protocol specification, to the print server 142 of the printing device 140. Once the printing device 140 receives the printing-initiated signal, it will request the image information that needs printing from the scanning device 100 via the storing client 144 inside the printing device 140. At this time, the storing server 118 inside the scanning device 100 will transmit the image information that needs printing to the printing device 140, based upon Picture Transfer Protocol (PTP). The image information will be transmitted to the printing device 140 via the transmission interface utilized by the interface controller 108. According to PictBridge protocol, preferably, the transmission interface utilized by the interface controller 108 can be a Universal Serial Bus (USB). The printing device 140 can do the printing job after receiving the image information. When the printing job is finished, the print server 142 of the printing device 140 will transmit a printing-completed signal, i.e., a message of “DPS_JOBEND” regulated in PictBridge protocol specification, to the print client 116 inside the scanning device 100 to notify that the scanning device 100 has finished the job.

Based upon the above explanation, the scanning device 100 can store image information to the storage device 120 or an image buffer after collecting image information of an object. To achieve the goal of successful printing, during the procedure of printing, the printing device 140 would convey the needs of printing to the print server 142 of the printing device 140 via the print client 116, and then request the image information that needs printing from the storage device 120 via the storing client 144 of the printing device 140. Continuingly, the storing server 118 in the scanning device 100 extracts the image information from the image buffer or the storage device 120 and transmits it to the printing device 140.

In contrast to prior art, the scanning device of the present invention is equipped with the print client, the storing server, and the storage device. The scanning device can connect the printing device directly. Also, the printing device can print directly any image information generated by the scanning device according to the PictBridge protocol and Picture Transfer Protocol (PTP). It is no longer necessary to print out image information via a computer. It would be greatly helpful in strengthening the function of the scanning device.

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention.

What is claimed is:

1. A scanning device for printing a scanning result via a printing device, comprising:
an image sensor module for scanning an object to generate an induced signal;
an image sensing circuit coupled to the image sensor module, for converting the induced signal into an image signal;
a system controller coupled to the image sensing circuit for processing the image signal to generate image information relating to the object;
a storage device for storing the image information;
a print client coupled to the system controller, for detecting an inquiry signal from the printing device, and responding a working signal; and
a storing server for transmitting the image information from the storage device to the printing device by using Picture Transfer Protocol (PTP).

2. The scanning device of claim 1 further comprising:
a motor for activating a movement of the image sensor module; and
a motor controller for driving the motor in response to a motor-driving signal from the system controller to activate the movement of the image sensor module.

3. The scanning device of claim 1, wherein the image sensor module comprises:
a light source for generating light to the object;
a lens for focusing the reflected light from the object; and
a photoelectric sensor for converting the sensing light intensity into the analog induced signal.

4. The scanning device of claim 1, wherein the working signal from the print client comprises a printing-initiated signal and an idling signal.

5. The scanning device of claim 1 further comprising an interface controller for transmitting the image information to the printing device.

6. The scanning device of claim 5, wherein the interface controller transmits the image information by using a Universal Serial Bus (USB) protocol.

7. A method of printing a scanning result of a scanning device via a printing device, the printing device comprising a print server and a storage client, the scanning device comprising a storing server, a print client, and a storage device, the method comprising:
linking the printing device and the scanning device, the printing device sending an inquiry signal to the scanning device;
scanning an object with the scanning device to generate an image information, and storing the image information into the storage device;
conveying a printing-initiated signal to the printing device when the scanning device generating a printing instruction;
the scanning device transmitting the image information to the printing device; and
the printing device printing out the image information.

8. The method of claim 7, wherein the printing device polls the inquiry signal to the scanning device, and the print client responds a working signal to the print server of the printing device.

9. The method of claim 8, wherein the working signal is an idling signal prior to the printing instruction.

10. The method of claim 7, wherein the print client of the scanning device transmits the image information to the printing device by using Picture Transfer Protocol (PTP)

11. The method of claim 7, wherein the print server sends a printing-completed signal to the print client after the printing device finishes printing out the image information.

12. The method of claim 7, wherein the print client detects the inquiry signal from the printing device in polling way.

13. The method of claim 7, wherein the scanning device transmits the image information to the printing device by means of an interface controller.

14. The method of claim 13, wherein the interface controller transmits the image information by using a Universal Serial Bus (USB) protocol.
